(19) United States
(12) Patent Application Publication
(10) Pub. No.: US 2002/0103666 A1
(43) Pub. Date: Aug. 1, 2002

(54) Server device, method for supporting sales performance, recording medium and data signal embodied in a carrier wave

(76) Inventors: Atsushi Hanai, Kanagawa (JP); Sachiko Misumi, Tokyo (JP); Keisuke Kataoka, Kanagawa (JP); Shizuo Kamimura, Kanagawa (JP); Eiji Shinohara, Kanagawa (JP); Tatsuto Torikai, Kanagawa (JP); Keiko Sakita, Kanagawa (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(21) Appl. No.: 10/055,917

(22) Filed: Jan. 28, 2002

(30) Foreign Application Priority Data
Jan. 29, 2001 (JP) 2001-020565
Jan. 29, 2001 (JP) 2001-020546

(51) Int. Cl. G06F 17/60

(52) U.S. Cl. 705/1

(57) ABSTRACT

A server sends a Web page including product information to at least one customer terminal, in response to accessing from the customer terminal. The server receives contact information sent from the customer terminal, in association with the sent Web page. The server acquires information regarding a customer corresponding to the at least one customer terminal, in accordance with the received contact information. The server acquires information regarding a corresponding sales staff, in accordance with the acquired information regarding the customer. The server sets an e-mail address included in the acquired information regarding the sales staff as an addressee. Then, the server sends an e-mail including the acquired information regarding the customer and the received contact information, to a sales staff terminal.

### BACKGROUND OF THE INVENTION

1. Field of the Invention

The present invention relates to a server device and a sales performance supporting method for desirably performing e-commerce (electronic commerce) and actual sales activities in cooperation with each other, and relates also to a recording medium recording the method and a data signal embodied in a carrier wave for realizing the above.

2. Description of the Related Art

Conventionally, it is very common in companies to perform sales activities, such as understanding the product usage of customers and demands for products and suggesting products conforming to the customers. In particular, a sales staff of a company visits each of his/her customers individually. At this time, the sales staff tries to establish reliable relationship with the customers and to understand the product usage of the customers and various demands about product items. To do this, the sales staff can suggest demanded products to the customers at just right time.

The companies usually collect and store information (e.g. user registration information, etc.) regarding customers who have purchased products before. The sales staff then uses thus stored information for his/her sales activities.

Since people now commonly use the Internet, the e-commerce is becoming in common use as well. For example, the user (a customer) operates a terminal, such as a personal computer or the like which is connectable to the Internet, to access a server (a Web site) of the companies, and browses a Web page including a product catalogue, etc. The user finds a desired product item in the product catalogue, the user then operates the terminal to input information including his/her name, address, number of items to be purchased and payment method, into a predetermined form. Then, the user sends the filled form to the server so as to purchase the desired product item.

It is common that such a Web site of the company has a membership system. In this case, to register as a member, each customer accesses the Web site in advance, and inputs required information in the Web page for registration. The Web site is accessed, and the registered information can be updated on the Web site.

Accordingly, the Web page including the product catalog is simply served on the server (the Web site), thereby the company can provide an infinite number of customers with product information and can receive order for products. That is, easy and effective sales activities can be realized using the e-commerce technique on the Internet.

Such an e-commerce system as a technique for sales activities is widely spread in companies. The customers can make an order for product items at home. Hence, this e-commerce is a very convenient way for the customers to order product items.

In reality, there are some product items which are not fit for being sold through the e-commerce technique. For example, those product items which are not fit for being sole through the e-commerce technique are expensive products, including copiers, automobiles, real estate, etc. That is, in the e-commerce technique wherein actual product items can not be seen or touched, the customers are likely to hesitate to purchase those products.

When purchasing large-sized product items or automobiles, etc., it is necessary to select a product item in consideration of the conditions on the user side. Hence, just like before, the customer talks with the sales staff who usually knows about the product items well, and selects a product item(s) afterwards. It can thus be the that those product items which are not good for being sold through the e-commerce should be the target product items to be sold in accordance with the traditional sales activities done conventionally in the companies.

However, in the case where to purchase (sell) product items (not target items to be sold using the e-commerce technique) through a sales staff based on the traditional sales activities, both customers and sales staff need to go through all the troublesome tasks. Particularly, the customer may make a telephone call to the sales staff, and tell the staff about the systematic conditions, etc. on the customer's side. The sales staff need to periodically visit his/her customers, and check demands for product items.

Therefore, for any of those product items which are not good for being sold using the e-commerce technique, it is demanded that a method for supporting sales performance done by the sale staff be established.

### SUMMARY OF THE INVENTION

The present invention has been made in consideration of the above. It is accordingly an object of the present invention to provide a server device and a sales performance supporting method for desirably performing e-commerce (electronic commerce) and actual sales activities in cooperation with each other, and also a recording medium recording the method and a data signal embodied in a carrier wave for realizing the method.

In order to attain the above object, according to the first aspect of the present invention, there is provided a server device comprising:

a communications section through which sends and receives predetermined information to and from at least one customer terminal and at least one sales-staff terminal which are connected with each other through a communications network;

a product-information sender which sends predetermined product information to the at least one customer terminal through the communications section;

a contact-information receiver which receives contact information sent from the at least one customer terminal in association with the product information sent by the product-information sender, through the communications section;

an information acquirer which acquires information regarding a customer corresponding to the at least one customer terminal, in accordance with the contact information received by the contact-information receiver; and

a sales-information sender which sends the information acquired by the information acquirer and the contact information received by the contact-information receiver, to the at least one sales-staff terminal through the communications section.

According to this invention, the communication section sends and receives the predetermined information to and from the at least one customer terminal and the at least one sales-staff terminal which are connected through the Internet, etc. The product-information sender sends the predetermined product information (e.g. a Web page, etc.) to the at least one customer terminal through the communication section. The contact-information receiver receives contact information sent from the at least one customer terminal, in association with the product information sent by the product-information sender, through the communication section. The information acquirer acquires information regarding a customer corresponding to the at least one customer terminal, in accordance with the contact information received by the contact-information receiver. The sales-information sender sends, in the form of, for example, an e-mail, the information acquired by the information acquirer and the contact information received by the contact-information receiver, to the at least one sales-staff terminal through the communication section. As a result, the e-commerce and the actual sales performance can be done in cooperation with each other.

The product-information sender may send a Web page including predetermined product information to the at least one customer terminal; and

the sales-information sender may send an e-mail including the information acquired by the information acquirer and the contact information received by the contact-information receiver, to the at least one sales-staff terminal.

The server device may further include:

a customer-information storage section which stores information regarding at least one registered customer, in advance; and

a staff-information storage section which stores information regarding at least one sales staff in association with the information stored in the customer-information storage section, and

wherein the information acquirer acquires information regarding the customer corresponding to the at least one customer terminal from the customer-information storage section, and acquires also the information regarding a sales staff corresponding to the customer from the staff-information storage section, and

the sales-information sender sends an e-mail including the information regarding the customer and acquired by the information acquirer and the contact information received by the contact-information receiver, to an e-mail address included in the information regarding the at least one sales staff and acquired by the information acquirer.

In order to attain the above object, according to the second aspect of the present invention, there is provided a method for supporting sales performance, comprising the steps of:

sending predetermined product information to at least one customer terminal via a communications network;

receiving contact information sent from the at least one customer terminal in association with the product information sent at the step of sending the product information;

acquiring information regarding a customer corresponding to the at least one customer terminal, in accordance with the contact information received at the step of receiving the contact information; and

sending the information acquired at the step of acquiring the information and the contact information received at the step of receiving the contact information, to at least one sales staff terminal through a communications network.

According to this invention, the step of sending the product information includes a step of sending predetermined product information (e.g. a Web page, etc.) to the at least one customer terminal through the Internet. The step of receiving the contact information includes a step of receiving the contact information sent from the at least one customer terminal, in association with the product information sent at the step of sending the product information. The step of acquiring the information includes a step of acquiring information regarding a customer corresponding to the at least one customer terminal, in accordance with the contact information received at the step of receiving the contact information. The step of sending the sales information includes a step of sending, in the form of, for example, an e-mail, the information acquired at the step of acquiring the information and the contact information received at the step of receiving the contact information, to the at least one sales-staff terminal through a communications network. As a result, the e-commerce and the actual sales performance can be realized in cooperation with each other.

The step of sending the product information may include a step of sending a Web page including the predetermined product information to the at least one customer terminal; and

the step of sending the sales information may include a step of sending an e-mail including the information acquired at the step of acquiring the information, the at least one sales staff terminal.

In order to attain the above object, according to the third aspect of the present invention, there is provided a method for supporting sales performance, comprising the steps of:

sending a Web page including product information, in response to accessing from at least one customer terminal through a communications network, to the at least one customer terminal;

receiving contact information sent from the at least one customer terminal in association with the product information sent at the step of sending the product information;

acquiring information regarding a customer corresponding to the at least one customer terminal, from a predetermined storage section storing customer information, in accordance with the contact information received at the step of receiving the contact information;

acquiring information regarding at least one corresponding sales staff, from a predetermined storage section storing sales staff information, in accordance with the information acquired at the step of acquiring the information regarding the customer; and

setting, as an addressee, an e-mail address included in the information acquired at the step of acquiring the information regarding the at least one corresponding sales staff, thereby sending an e-mail including the information acquired at the step of acquiring the customer information and the contact information received at the step of receiving the contact information, the to at least one sales-staff terminal of the at least one corresponding sales staff through a communications network.

According to this invention, the step of sending the product information includes a step of sending a Web page including the product information, in response to accessing from the at least one customer terminal through a communications network, to the at least one customer terminal. The step of receiving the contact information includes a step of receiving the contact information sent from the at least one customer terminal, in association with the Web page sent at the step of sending the product information. The step of acquiring the customer information includes a step of acquiring information regarding a customer corresponding to the at least one customer terminal, from the customer-information database storing the customer information, in accordance with the contact information received at the step of receiving the contact information. The step of acquiring the staff information includes a step of acquiring information regarding a corresponding sales staff, from the staff-information database, etc. storing the staff information, in accordance with the information acquired at the step of acquiring the customer information. The step of sending the sales information includes a step of sending an e-mail, including the information acquired at the step of acquiring the customer information and the contact information received at the step of receiving the contact information, to the at least on sales-staff terminal through a communications network. As a result of this, the e-commerce and the actual sales performance can be achieved in cooperation with each other.

In order to attain the above object, according to the fourth aspect of the present invention, there is provided a computer readable recording medium recording a program for controlling a computer to execute a method for supporting sales performance comprising the steps of:

sending predetermined product information to at least one customer terminal via a communications network;

receiving contact information sent from the at least one customer terminal in association with the product information sent at the step of sending the product information;

acquiring information regarding a customer corresponding to the at least one customer terminal, in accordance with the contact information received at the step of receiving the contact information; and

sending the information acquired at the step of acquiring the information and the contact information received at the step of receiving the contact information, to at least one sales staff terminal through a communications network.

In order to attain the above object, according to the fifth aspect of the present invention, there is provided a data signal embodied in a carrier wave and representing an instruction sequence for controlling a computer to execute a method for supporting sales performance comprising the steps of:

sending predetermined product information to at least one customer terminal via a communications network;

receiving contact information sent from the at least one customer terminal in association with the product information sent at the step of sending the product information;

acquiring information regarding a customer corresponding to the at least one customer terminal, in accordance with the contact information received at the step of receiving the contact information; and

sending the information acquired at the step of acquiring the information and the contact information received at the step of receiving the contact information, to at least one sales staff terminal through a communications network.

In order to attain the above object, according to the sixth aspect of the present invention, there is provided a server device comprising:

a communications section which sends and receives predetermined information to and from at least one customer terminal and at least one sales-staff terminal connected with each other through a communications network;

a product-information sender which sends predetermined product information to the at least one customer terminal through the communications section;

a request-information receiver which receives request information sent form the at least one customer terminal in association with the product information sent by the product-information sender, through the communications section;

an information acquirer which acquires information regarding a customer corresponding to the at least one customer terminal and product information corresponding to the request information, in accordance with the request information received by the request-information receiver; and

a sales-information sender which sends the information acquired by the information acquirer to the at least one sales-staff terminal through the communications section.

According to this invention, the communications section sends and receives predetermined information to and from the at least one customer terminal and the at least one sales-staff terminal through the Internet, etc. The product-information sender sends predetermined product information (e.g. a Web page) through the communications section, to the at least one customer terminal. The request-information sender receives the request information sent from the at least one customer terminal through the communications section, in association with the product information sent by the product-information sender. The information acquirer acquires the information regarding a customer corresponding to the at least one customer terminal and the product information corresponding to the request information, in accordance with the request information received by the request-information receiver. The sales-information sender sends the information acquired by the information acquirer to the at least one sales-staff terminal through the communications section, in the form of, for example, an e-mail. As a result, the e-commerce and the actual sales performance can be realized in cooperation with each other.

The product-information sender may send a Web page including the predetermined product information to the at least one customer terminal; and

the sales-information sender may send an e-mail including the information acquired by the information acquirer to the at least one sales-staff terminal.

In order to attain the above object, according to the seventh aspect of the present invention, there is provided a server device comprising:

a customer-information storage section which stores in advance information regarding at least one registered customer;

a staff-information storage section which stores information regarding at least one sales staff in association with information regarding the at least one customer stored in the customer-information storage section;

a communications section which sends and receives predetermined information to and from at least one customer terminal and at least one sales-staff terminal through a communications network;

a customer-information sender which sends the information stored in the customer-information storage section to the at least one customer terminal through the communications section;

a request-information receiver which receives request information, sent from the at least one customer terminal in association with the information sent by the customer-information sender and for requesting to update registered information, through the communications section;

an information updating section which updates the information regarding the at least one customer and being received by the request-information receiver; and

a sales-information sender which sends the information updated by the information updating section, to the at least one sales-staff terminal through the communications section.

According to this invention, the customer-information storage section stores information regarding at least one registered customer in advance. The staff-information storage section stores information regarding at least one sales staff and the information stored in the customer-information storage section. The communications section sends and receives predetermined information to and from the at least one customer terminal and the at least one sales-staff terminal through the Internet. The customer-information sender sends information (e.g. a Web page) corresponding to the at least one customer terminal stored in the customer-information storage section, to the at least one customer terminal through the communication section. The request-information receiver receives the request information, sent from the at least one customer terminal in association with the information sent by the customer-information sender and for requesting to update the registered information, through the communications section. The information updating section updates the information stored in the customer-information storage section, in accordance with the request information received by the request-information receiver. The sales-information sender sends the information updated by the information updating section to the at least one sales-staff terminal through the communications section, in the form of, for example an e-mail. As a result of this, the e-commerce and the sales performance can be successfully realized in cooperation with each other.

The customer-information sender may send a Web page including the customer information corresponding to the at least one customer terminal to the at least one customer terminal; and

the sales-information sending section may send an e-mail including the information updated by the information updating section, to the at least one sales-staff terminal.

In order to attain the above object, according to the eighth aspect of the present invention, there is provided a method for supporting sales performance, comprising the steps of:

sending predetermined product information, in response to accessing from at least one customer terminal through a communications network, to the at least one customer terminal;

receiving request information sent from the at least one customer terminal in association with the product information sent at the step of sending the product information;

acquiring information regarding a customer corresponding to the at least one customer terminal and the product information corresponding to the request information, in accordance with the request information received at the step of receiving the request information; and

sending the information acquired at the step of acquiring the information to the at least one sales-staff terminal through a communications network.

According to this invention, the step of sending the product-information includes a step of sending predetermined product information (e.g. a Web page, etc.), in response to accessing from at least one customer terminal through a communications network, to the at least one customer terminal. The step of receiving the request information includes a step of receiving the request information sent from the at least one customer terminal, in association with the product information sent at the step of sending the product information. The step of acquiring the information includes a step of acquiring the product information corresponding to the request information and the information regarding a customer of the at least one customer terminal, in accordance with the request information received at the step of receiving the request information. The step of sending the sales information includes a step of sending information acquired at the step of acquiring the information to the at least one sales-staff terminal through a communications network, in the form of, for example an e-mail. As a result of this, the e-commerce and the actual sales performance can satisfactorily be realized in cooperation with each other.

The step of sending the product information may include a step of sending a Web page including the predetermined product information to the at least one customer terminal; and

the step of sending the sales information may include a step of sending an e-mail including the information acquired at the step of acquiring the information, to the at least one sales-staff terminal.

In order to attain the above object, according to the ninth aspect of the present invention, there is provided a method for supporting sales performance, comprising the steps of:

sending information regarding at least one customer registered in a predetermined storage section, in response to accessing from the at least one customer terminal through a communications network, to the at least one customer terminal;

receiving request information, sent from the at least one customer terminal in association with the customer information sent at the step of sending the customer information and representing a request for updating registered information;

updating the information registered in the predetermined storage section, in accordance with the request information received at the step of receiving the request information; and

sending the information updated at the step of updating the information, to at least one sales-staff terminal through a communications network.

According to this invention, the step of sending the customer information includes a step of sending information (e.g. a Web page) regarding a customer registered in a customer-information database, in response to accessing from at least one customer terminal through a communications network, to the at least one customer terminal. The step of receiving the request information includes a step of receiving the request information, sent from the at least one customer terminal in association with the customer information sent at the step of sending the customer information and for requesting to update registered information. The step of updating the information includes a step of updating the information registered in the customer-information database, in accordance with the request information received at the step of receiving the request information. The step of sending the sales information includes a step of sending the information updated at the step of updating the information to the at least one sales-staff terminal through a communications network, in the form of, for example, an e-mail. As a result, the e-commerce and the actual sales performance can be achieved in cooperation with each other.

The step of sending the customer information may include a step of sending a Web page including the customer information corresponding to the at least one customer terminal, to the at least one customer terminal; and

the step of sending the sales information may include a step of sending an e-mail including the information updated at the step of updating the information, to the at least one sales-staff terminal.

In order to attain the above object, according to the tenth aspect of the present invention, there is provided a computer readable recording medium recording a program for controlling a computer to execute a method for supporting sales performance, the method comprising the steps of:

sending predetermined product information, in response to accessing from at least one customer terminal through a communications network, to the at least one customer terminal;

receiving contact information sent from the at least one customer terminal in association with the product information sent at the step of sending the product information;

acquiring information regarding a customer corresponding to the at least one customer terminal and the predetermined product information corresponding to the request information, in accordance with the request information received at the step of receiving the request information; and

sending the information acquired at the step of acquiring the information to at least one sales-staff terminal through a communications network.

In order to attain the above object, according to the eleventh aspect of the present invention, there is provided a computer readable recording medium recording a program for controlling a computer to execute a method for supporting sales performance, the method comprising the steps of:

sending information regarding a customer and being stored in a predetermined storage section, in response to accessing from at least one customer terminal through a communications network, to the at least one customer terminal;

receiving request information for requesting to update registered information, sent from the at least one customer terminal in association with the customer information sent at the step of sending the information;

updating the customer information stored in the predetermined storage section, in accordance with the request information received at the step of receiving the request information; and

sending the customer information updated at the step of updating the customer information, to at least one sales-staff terminal through a communications network.

In order to attain the above object, according to the twelfth aspect of the present invention, there is provided a data signal embodied in a carrier wave and representing an instruction sequence for controlling a computer to execute a method for supporting sales performance, the method comprising the steps of:

sending predetermined product information, in response to accessing from at least one customer terminal through a communications network, to the at least one customer terminal;

receiving request information sent from the at least one customer terminal in association with the product information sent at the step of sending the product information;

acquiring information regarding a customer of the at least one customer terminal and the product information corresponding to the request information, in accordance with the request information received at the step of receiving the request information; and

sending the information acquired at the step of acquiring the information to at least one sales-staff terminal through a communications network.

In order to attain the above object, according to the thirteenth aspect of the present invention, there is provided a data signal embodied in a carrier wave and representing an instruction sequence for controlling a computer to execute a method for supporting sales performance, the method comprising the steps of:

sending information regarding a customer registered in a predetermined storage section, in response to accessing from at least one customer terminal through a communications network, to the at least one customer terminal;

receiving request information sent from the at least one customer terminal in association with the customer information sent at the step of sending the customer information;

updating the information regarding the customer stored in the predetermined storage section, in accordance with the request information received at the step of receiving the request information; and

sending the information including the information updated at the step of updating the information to at least one sales-staff terminal through a communications network.

### BRIEF DESCRIPTION OF THE DRAWINGS

The object and other objects and advantages of the present invention will become more apparent upon reading of the following detailed description and the accompanying drawings in which:

FIG. 1 is a diagram exemplarily showing one structure of a sales support system according to the first embodiment of the present invention;

FIG. 2 is a block diagram exemplarily showing one structure of a server included in the sales support system of FIG. 1;

FIG. 3A is a diagram exemplarily showing information stored in a customer-information database, and

FIG. 3B is a diagram exemplarily showing information stored in sales-staff-information database;

FIG. 4 is a flowchart for explaining a product/sales information transmission process to be executed by the sales support system according to the first embodiment;

FIG. 5 is a diagram exemplarily showing a log-in page to be sent from the server to user terminals;

FIG. 6 is a diagram exemplarily showing a product-information page to be sent from the server to user terminals;

FIG. 7 is a diagram exemplarily showing a “contact form” to be sent from the server to user terminals;

FIG. 8 is a diagram exemplarily showing one structure of a sales support system according to the second embodiment of the present invention;

FIG. 9 is a block diagram showing one structure of a server included in the sales support system of FIG. 8;

FIG. 10 is a diagram exemplarily showing information to be stored in a product-information database;

FIG. 11 is a flowchart for explaining a product/sales information transmission process executed by the sales support system according to the second embodiment;

FIG. 12A is a diagram exemplarily showing a log-in page to be sent from the server to user terminals, and

FIG. 12B is a diagram exemplarily showing a menu page to be sent from the server to user terminals;

FIG. 13 is a flowchart for explaining an information providing process;

FIG. 14A is a diagram exemplarily showing a registration updating form to be sent from the server to user terminals, and

FIG. 14B is a diagram exemplarily showing a product-information page to be sent from the server to user terminals;

FIG. 15 is a diagram exemplarily showing a notice-confirmation page to be sent from the server to user terminals; and

FIG. 16 is a flowchart for explaining an e-mail transmission process.

### DETAILED DESCRIPTION OF THE PREFERRED EMBODIMENTS

Preferred embodiments of the present invention will now be described with reference to the accompanying drawings.

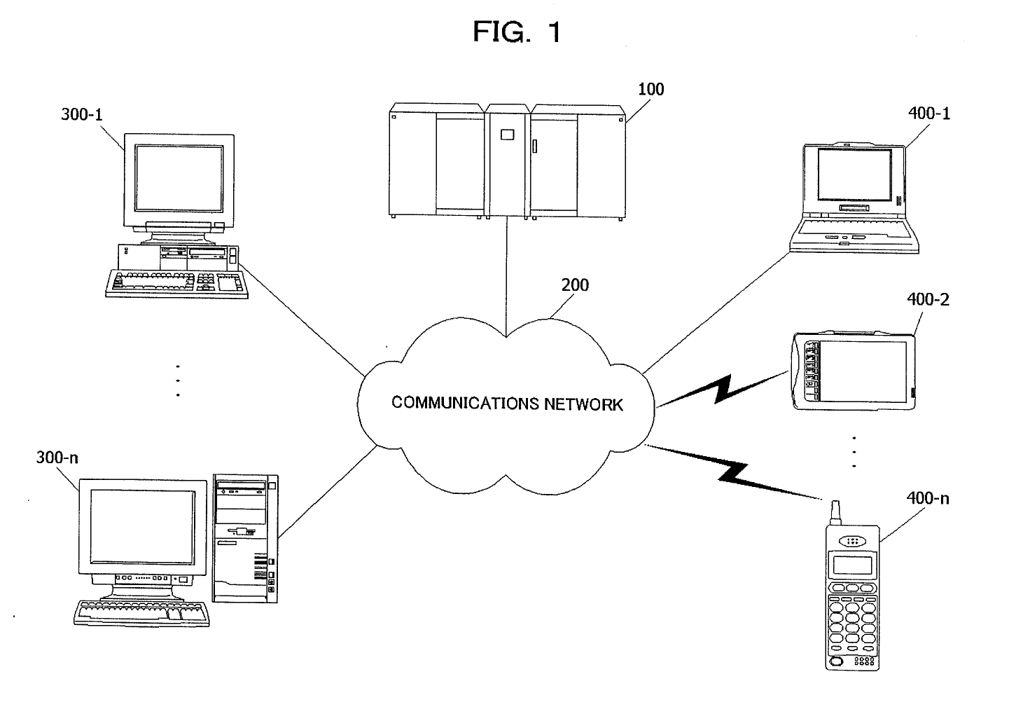

FIG. 1 is a diagram exemplarily showing one structure of a sales support system according to the first embodiment of the present invention. As shown in FIG. 1, the sales support system comprises a server 100, a communications network 200, a user terminal 300 (including a plurality of user terminals 300-1 to 300-n) and a sales-staff terminal 400 (including a plurality of sales-staff terminals 400-1 to 400-n). Note that the sales support system of this embodiment is a system for dealing relatively large-sized product items, such as copiers, etc.

The server 100 includes, for example, a mainframe computer, a workstation, etc., and is controlled appropriately by a sales company, or the like. The server 100 provides the user terminal 300 with product information or the like through the communications network, and informs the sales-staff terminal 400 about sales information, etc. The structure of the server 100 will more specifically be described later.

The communications network 200 includes, for example, a network, such as the Internet or the like, and connects the server 100, the user terminal 300 and the sales-staff terminal 400 with one another.

The user terminal 300 (including the plurality of terminals 300-1 to 300-n) is a terminal which is operated by a customer (a user), and includes a personal computer including a controller, a storage section and a display section and the like, or includes a portable information terminal which can receive and display Web pages. The user terminal 300 connects with the communications network 200 through a communications device, such as a modem, TA (a Terminal Adapter), and receives and sends predetermined information from and to the server 100 or the like.

A program (browser or the like) for browsing Web pages is installed in advance in the storage section of the user terminal 300. The controller (a CPU or the like) of the user terminal 300 executes the installed program, and receives Web pages provided from the server 100 through the communications network 200. The display section of the user terminal 300 displays the received Web pages, and thus letting the customer browse the Web pages.

The sales-staff terminal 400 (including the plurality of terminals 400-1 to 400-n) is a terminal which is operated by the sales staff of the sales company, etc., and includes a small personal computer, a portable information terminal, such as a PDA (Personal Data Assistants), or a cellular phone or PHS (Personal Handy-phone System) which can send and receive e-mails to and from other terminals.

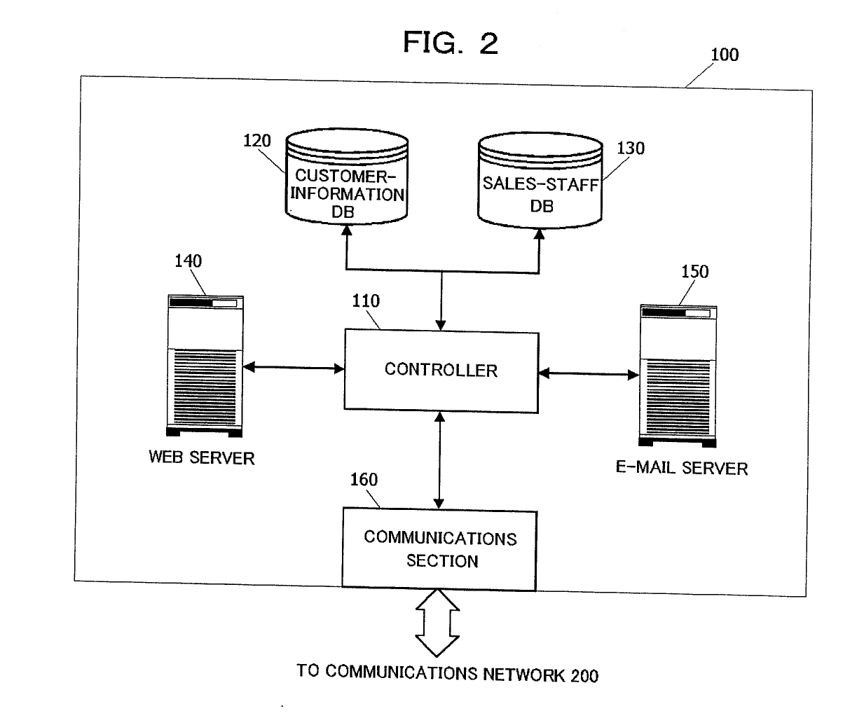

The server 100 will now specifically be described with reference to FIG. 2.

FIG. 2 is a block diagram showing an example of the structure of the server 100. As shown in FIG. 2, the server 100 comprises a controller 110, a customer-information database 120, a sales-staff database 130, a Web server 140, an e-mail server 150 and a communications section 160.

The controller 110 includes a CPU (Central Processing Unit) or the like, and controls the entire operations of the server 100. Specifically, the controller 110 executes an operational program stored in a non-illustrative memory, and carries out a product/sales information transmission process, as will be described later.

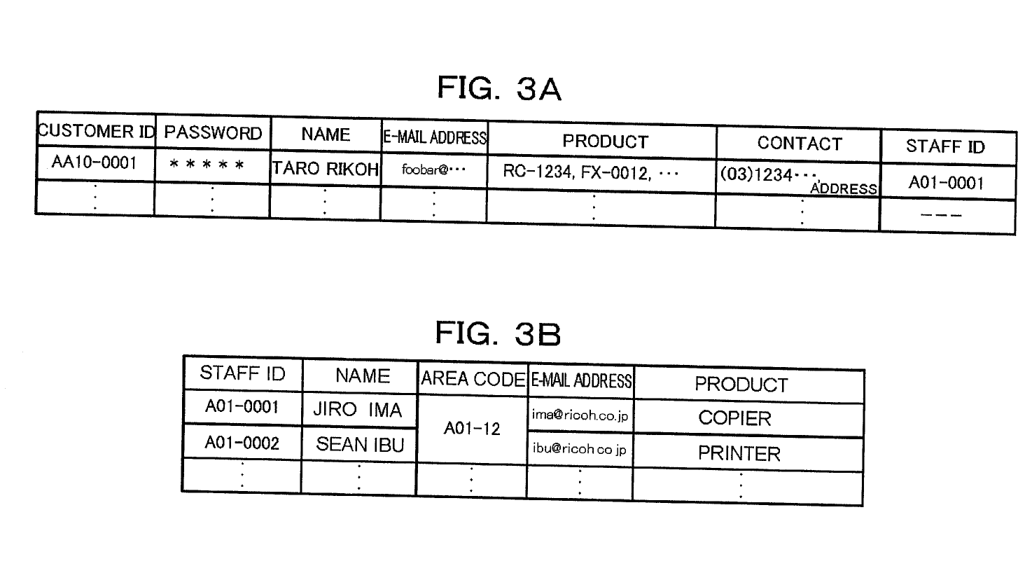

The customer-information database 120 includes a re-writable storage device, such as a hard-disk device, etc., and stores customer information shown in FIG. 3A.

As shown in FIG. 3A, the customer information includes information items of “customer ID” for identifying a customer, a “password” for authenticating the customer, a “customer name”, an “e-mail address” of the customer (through which e-mails can be received at the user terminal 300), a “product item” possessed by the customer (i.e. a product item that the customer has purchased from the sales company), a “phone number” or “address” of the customer and a “staff ID” for identifying the corresponding sales staff.

The sales-staff database 130 includes a re-writable storage device, such as a hard-disk device, etc., and stores the staff information shown in FIG. 3B.

As illustrated in FIG. 3B, the sales-staff information includes information items of a “sales-staff ID” for identifying a corresponding sales staff, a “staff name”, an “area code” that the sales staff is in charge of, an “e-mail address” (through which e-mails can be received at the sales-staff terminal 400) and a “product item” that the sales staff is in charge of.

As illustrated in FIG. 2, the Web server 140 includes a server device including a controller, storage device, etc., creates Web pages including product information, and provides the user terminal 300 with the created Web pages via the communications section 160. Particularly, the storage device of the Web server 140 stores product information (characteristics of product items, the price of each product item and the image of the product item) regarding those product items to be sold. The product information is updated occasionally by the controller 110, etc. The storage device of the Web server 140 stores also a program for creating Web pages. The controller of the Web server 140 executes this program to create Web pages including product information and update the created Web pages.

The e-mail server 150 includes a server device including a controller, a storage device and the like, and creates and send an e-mail addressed to the sales staff (the sales-staff terminal 400). Specifically, the storage device of the e-mail server 150 stores in advance some set sentences or a template form of e-mails. The storage device of the e-mail server 150 stores also a program for sending and receiving e-mails. The controller of the e-mail server 150 executes this program, thereby creating e-mails using the set sentences or template. Further, the controller refers to the sales-staff information, etc. shown in FIG. 3B, and sends an e-mail addressed to a corresponding sales staff (the sales-staff terminal 400).

The communications section 160 includes a communications device, such as a router or TA (a Terminal Adapter), for example. The communications section 160 sends and receives predetermined information to and from the user terminal 300 and the sales-staff terminal 400, through the communications network 200. Specifically, the communications section 160 can be accessed by the user terminal 300, and sends the Web pages created by the Web server 140 to the user terminal 300 having accessed the communications section 160. The communications section 160 sends the e-mails created by the e-mail server 150 to the sales-staff terminal 400 through the communications network 200.

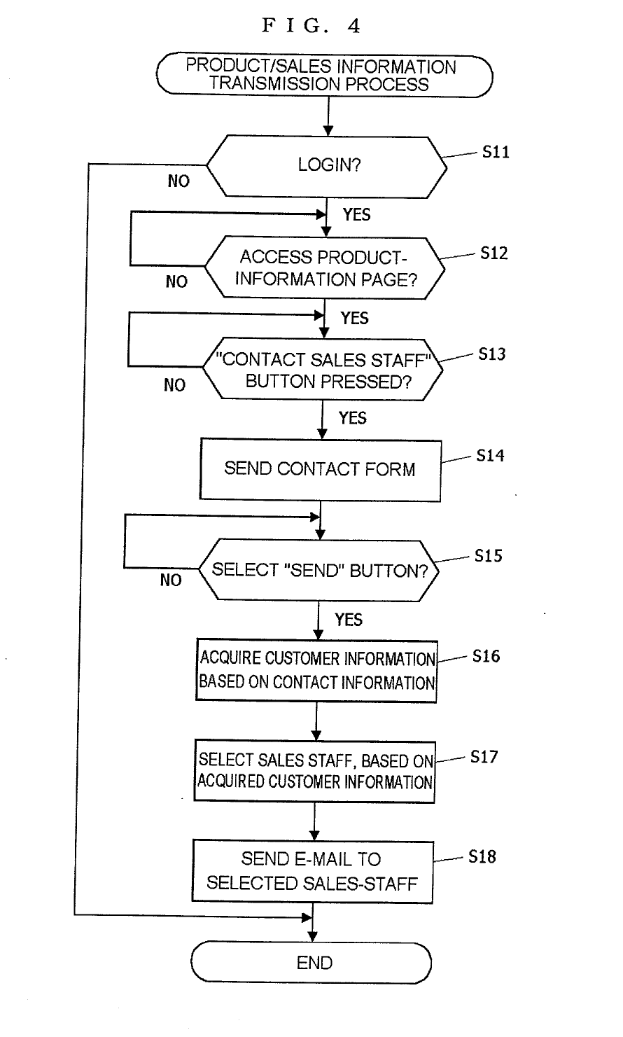

Operations of the sales support system according to the first embodiment of the present invention will now be explained with reference to FIG. 4.

FIG. 4 is a flowchart for explaining a product/sales information transmission process to be carried out by the controller 110 of the server 100. This transmission process is executed in accordance with the program stored in advance in the memory of the controller 110.

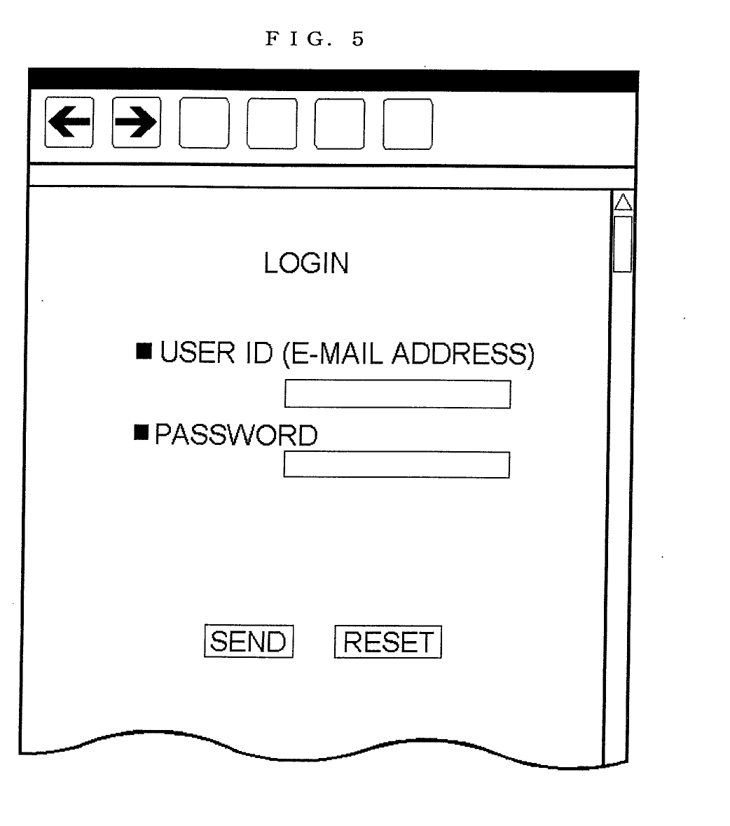

Immediately after the user terminal 300 accesses the server 100, the controller 110 sends a log-in page for performing user authentication to the user terminal 300 and accepts a login request from the user terminal 300 (Step S11). Specifically, upon reception of an access request from the user terminal 300 via the communications section 160, the controller 110 controls the Web server 140 to create a “LOGIN” page shown in FIG. 5. The controller 110 sends this “LOGIN” page to the user terminal 300 having sent the access request, via the communication section 160.

The user terminal 300 receives the “LOGIN” page sent from the server 100, and displays the received “LOGIN” page on the display section. After login information, including the user ID (the customer ID), password, etc. is input into the “LOGIN” page by the customer, the user terminal 300 sends the input login information to the server 100.

Upon reception of the login information from the user terminal 300, the controller 110 searches the customer-information database 120 for a combination of the corresponding customer ID and password.

In the case where the controller 110 can not find out a corresponding combination of the above from the customer-information database 120 (Step S11: NO), it concludes that the requested user terminal 300 is not a registered customer, and terminates the transmission process.

In the case where the corresponding combination of the customer ID and password is successfully searched out (Step S11: YES), the controller 110 authorizes the user terminal 300 to log in to the Web server 140. At this time, the Web server 140 sends a cookie file, etc. including customer ID information to the corresponding user terminal 300. Based on this cookie file, the Web server 140 identifies any user terminal 300 which may try to access the Web server 140 afterwards.

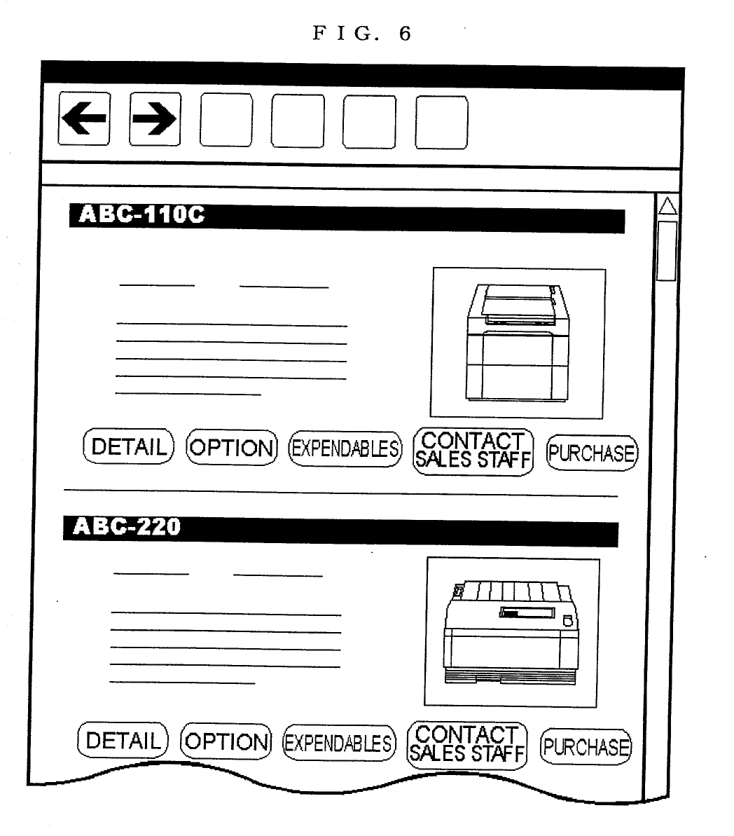

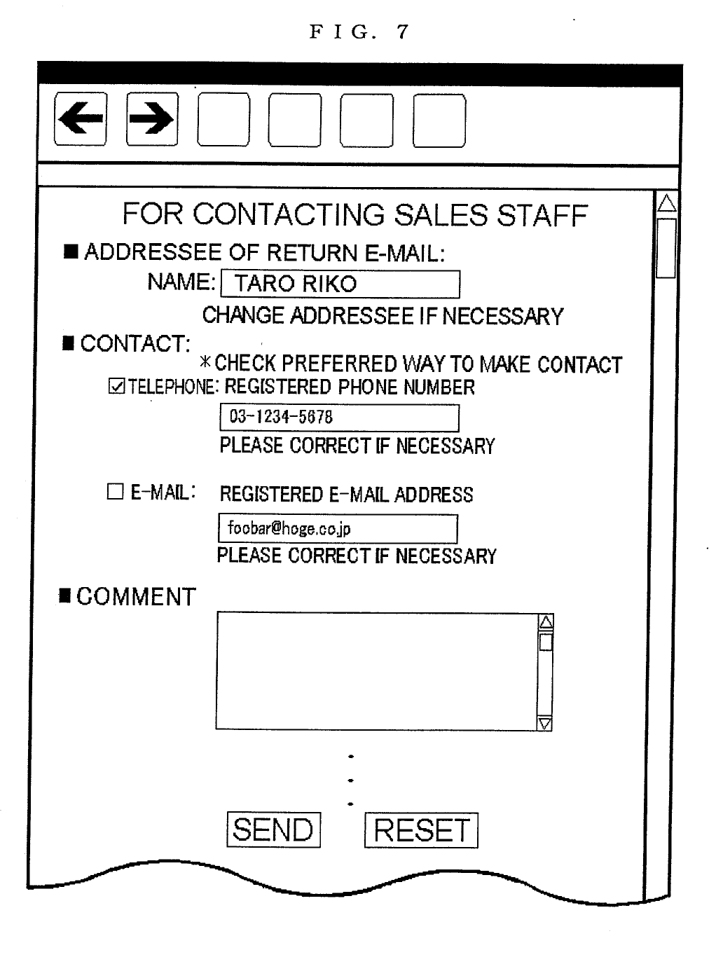

The controller 110 stands by the user terminal 300 accessing a product information page including product information (Step S12). In response to accessing from the user terminal 300, the controller 110 sends the product information page to the user terminal 300. Specifically, the controller 110 controls the Web server 140, creates the product information page shown in FIG. 6, and sends the created product information page to the user terminal 300 through the communications section 160.

The user terminal 300 receives the product information page sent from the server 100, and displays the received page on the display section. As illustrated in FIG. 6, in this product information page, descriptions and images of product items are given.

In the product information page, there are set several buttons of “Detail”, “Option”, “Expendable Supplies”, “Contact Sales Staff” and “Purchase”, in association with each product item. Each of those button images corresponds to a corresponding Web page so as to be linked thereto. For example, upon selection of “Detail” button (by clicking on the button “Detail” using a mouse, etc.), a Web page including the detail information of the corresponding product item is read out, in accordance with the link, and the read Web page is displayed on the user terminal 300.

The controller 110 stands by the selection of “Contact Sales Staff”, as done by the user terminal 300 (Step S13).

For example, the customer who has read out the product information page shown in FIG. 6 may want to contact the sales staff and ask about a predetermined product item. In this case, the customer operates the user terminal 300, and selects the button “Contact Sales Staff”.

In this way, upon selection of the button “Contact Sales Staff”, the user terminal 300 sends request information for requesting a “contact form”, to the server 100. This request information includes information regarding model numbers specifying product items.

Upon selection of the button “Contact Sales Staff” and reception of the request information from the user terminal 300, the controller 110 creates a “contact form” and sends the created “contact form” to the user terminal 300 (Step S14). Specifically, the controller 110 controls the Web server 140 to create a “contact form” in preset format. The controller 110 reads out corresponding customer information from the customer-information database 120. Then, the controller 110 inserts information representing the customer name, a customer phone number, an e-mail address of the corresponding customer, into the “contact form”, so as to create the “contact form” shown in FIG. 7. The controller 110 adds information representing a model number of a product item into the “contact form” as, for example, hidden information.

The controller 110 sends thus created “contact form” to the user terminal 300.

The user terminal 300 receives and displays the “contact form” sent from the server 100. As shown in FIG. 7, in the “contact form”, some information including the customer name, the customer phone number and the e-mail address of the customer are included. Hence, the customer needs not input such information every time he/she tries to contact the sales staff by operating the user terminal 300. In the case where the customer wants to update the registered phone number or e-mail address, the customer simply has to input information in the “contact form”.

As shown in FIG. 7, the “contact form” includes a space for a comment. If the customer has something to ask the sales staff, he/she can input a question or the like in this space. Let it be assumed that the “contact form” includes a check box for selecting a predetermined action (transmission of some information, explanation about a product item face to face or on the phone, etc.) to be done by the sales staff.

In addition, the “contact form” includes buttons of “send”, “reset” and the like. For example, the button “send” is prepared for sending the information input in the “contact form” and is selected by the customer.

The controller 110 stands by the selection of the button “send” by the user terminal 300 (Step S15).

Upon selection of the button “send”, the user terminal 300 sends contact information including the information input in the “contact form”, to the server 100. This contact information includes also information representing a model number specifying a target product item.

Upon selection of the button “send” and reception of the contact information from the user terminal 300, the controller 110 acquires customer information based on the received contact information (Step S16). That is, the controller 110 searches the customer-information database 120 for corresponding customer information.

The controller 110 selects a sales staff based on the acquired customer information (Step S17). Specifically, in the case where a staff ID is set in the customer information acquired from the customer-information database 120, the controller 110 selects the sales staff in association with the staff ID. On the contrary, in the case where no staff ID is set in the customer information, the controller 110 obtains an area code using the address, etc. included in the customer information, and acquires information (such as a model number of a product item, etc.) for specifying a product item included in the contact information. The controller 110 searches the sales-staff database 130 for a sales staff being in charge of the target product item in the area code, based on the area code and model number of the product item.

The controller 110 sends an e-mail to the searched sales staff (Step S18). Specifically, the controller 110 searches the sales-staff database 130 for an e-mail address in association with the staff ID of the searched sales staff. After this, the controller 110 reads out the customer name, the customer phone number, the e-mail address of the customer and the contents of the comment space which are all included in the contact information, and creates an e-mail including the read information. At this time, the e-mail address of the sales staff is set as the addressee of the created e-mail.

The controller 110 controls the e-mail server 150 and sends the created e-mail to the e-mail address of the sales staff. The sales-staff terminal 400 detects whether the e-mail has been received at a predetermined timing, retrieves the e-mail into the terminal in accordance with the operations of the sales staff, and displays the retrieved e-mail thereon. The sales staff carries out sales activities, by specifying a target customer based on the e-mail displayed on the sales-staff terminal 400 and making contact with the specified customer.

According to the above-described product/sales information transmission process, e-commerce and the actual business activities can be achieved in association with each other.

In the above-described embodiment, the explanations have been made to the case where the e-mail is sent to the sales staff upon reception of the contact information from the user terminal 300. However, the timing for sending the e-mail to the sales staff is not limited to the above, and the e-mail can be sent thereto at any time it is preferred. For example, the e-mail can be sent to the sales staff, immediately after the user terminal 300 sends a request for information regarding a product item that the customer of the user terminal 300 does not possess.

In this case, the sales staff can easily be aware of the fact that the customer is thinking to purchase a new product item. Hence, the sales staff can carry out effective business activities in relation to the new product item for the customer.

The addressee of the e-mail to be sent is arbitrary and not limited to the sales staff. For example, in addition to the sales staff, the e-mail may be sent also to an administrator of the customer-information at the sales company, etc.

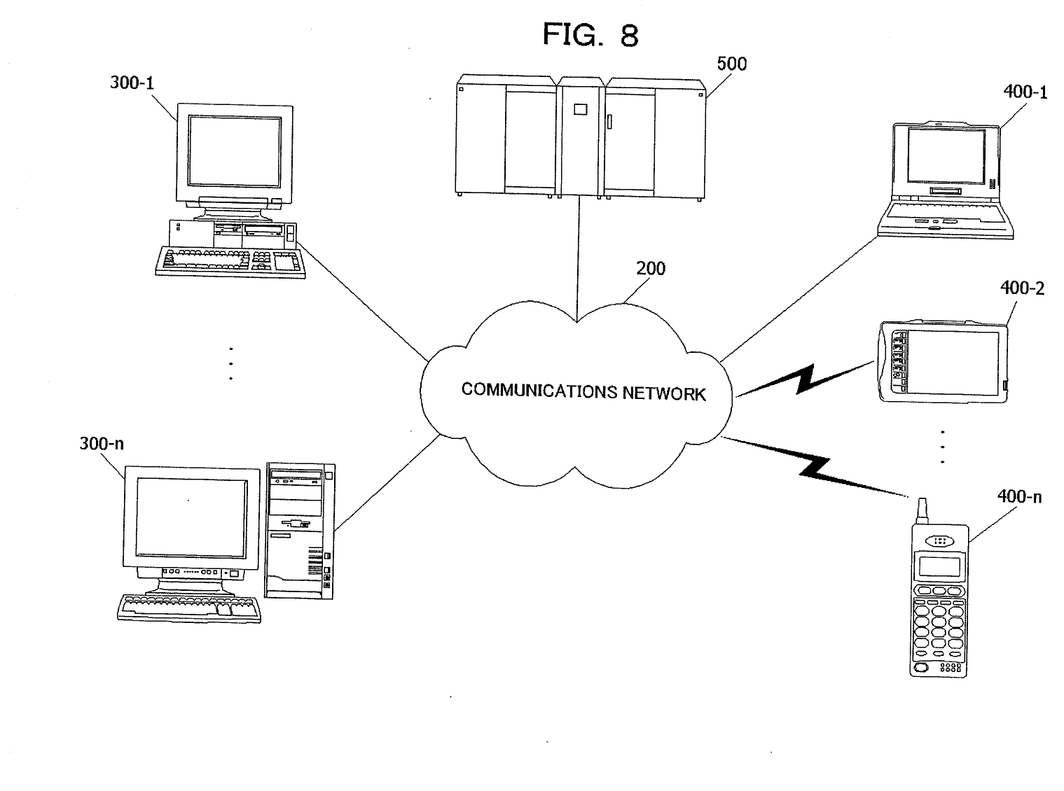

A sales support system according to the second embodiment of the present invention will now be explained with reference to the accompanying drawings. FIG. 8 is a diagram exemplarily showing one structure of the sales support system according to the second embodiment. As shown in FIG. 8, the sales support system comprises a server 500, a communications network 200, a user terminal 300 (including a plurality of user terminals 300-1 to 300-n) and a sales-staff terminal 400 (including a plurality of sales-staff terminals 400-1 to 400-n). This sales support system is a system for dealing relatively large-sized product items, such as copiers, etc.

The communications network 200, the user terminal 300 and the sales-staff terminal 400 have the same structure as those included in the sales support system according to the first embodiment.

The server 500 includes a mainframe computer, a workstation, or the like, and is managed by the sales company, etc. The server 500 provides the user terminal 300 with product information and informs the sales-staff terminal 400 about sales information, via the communications network 200.

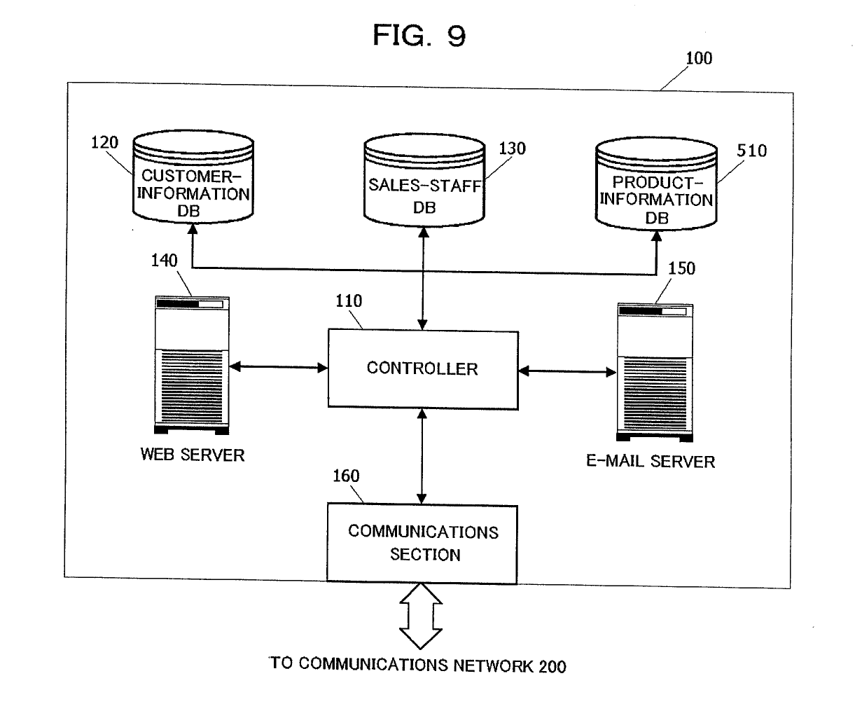

As shown in FIG. 9, the server 500 comprises a controller 110, a customer-information database 120, a sales-staff database 130, a Web server 140, an e-mail server 150, a communications section 160 and a product-information database 510.

The structure of each of the controller 110, customer-information database 120, sales-staff database 130, Web server 140, e-mail server 150, communications section 160 and product-information database 510 is the same as that included in the server 100 shown in FIG. 2.

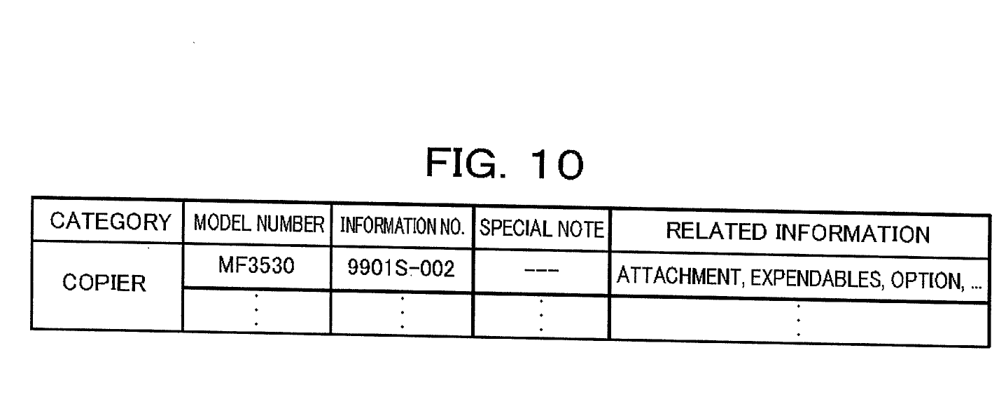

The product-information database 510 includes a re-writable storage device, such as a hard disk device, etc., and stores product information shown in FIG. 10.

As shown in FIG. 10, the product information includes information items of “product category”, “model number” for specifying a product item, “information No.” for specifying a catalog which shows the product item, “special note” about the product item and “related information” including attachment information, expendable supply information, option information, etc.

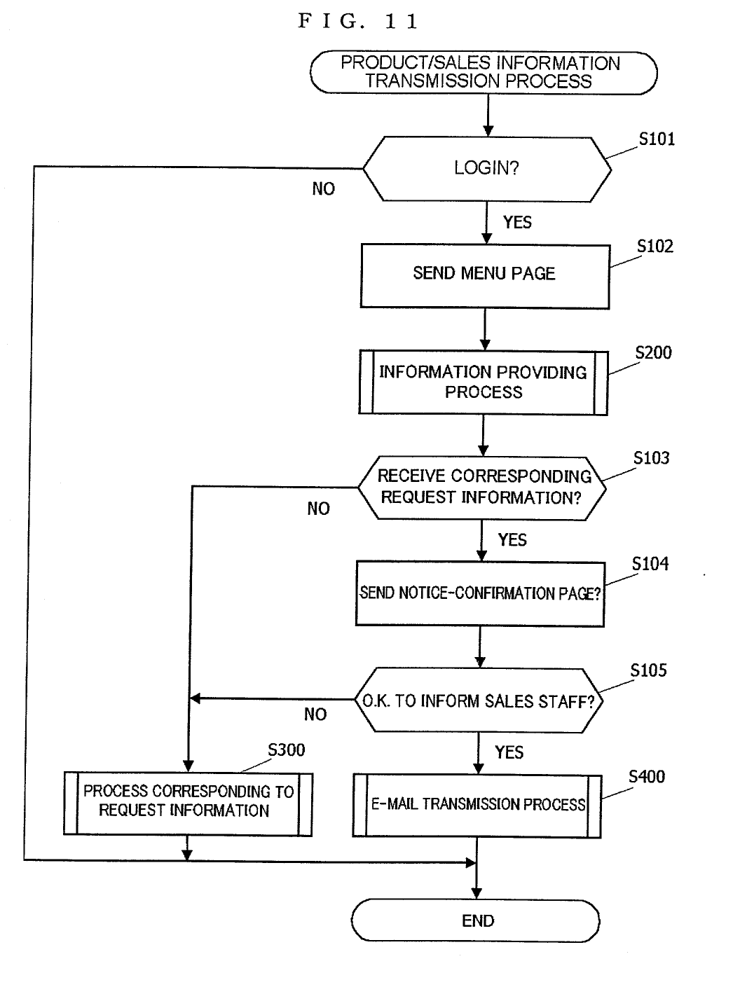

Operations of the sales support system according to the second embodiment of the present invention will now be described with reference to FIG. 11.

FIG. 11 is a flowchart for explaining a product/sales information transmission process which is carried out by the controller 110 included in the server 500. This process is carried out by a program stored in advance in the memory of the controller 110.

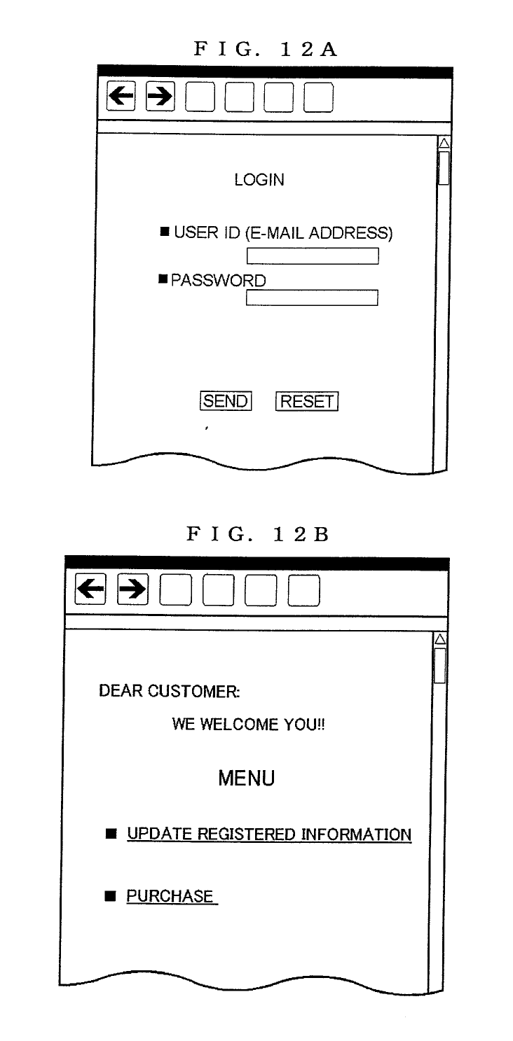

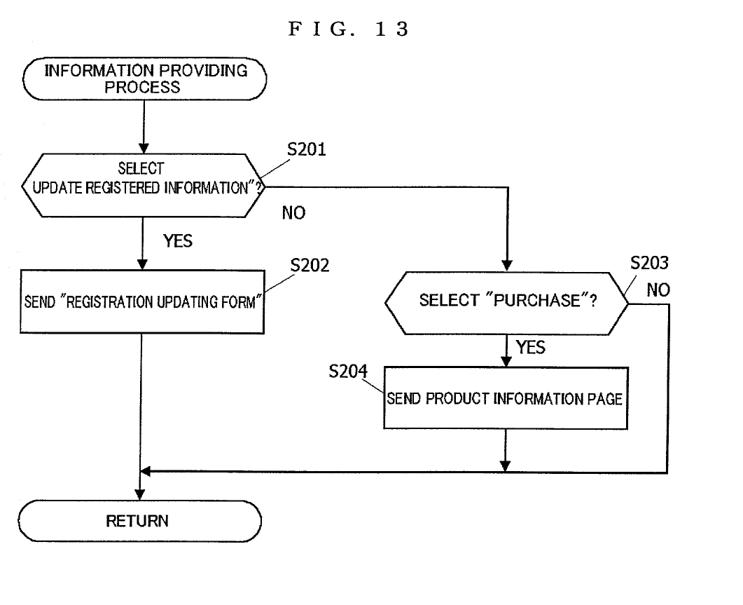

If the user terminal 300 accesses the server 500, the controller 110 sends a login page for performing user authentication to the user terminal 300, and accepts a login request (Step S101). Specifically, the controller 110 controls the Web server 140 to create a “LOGIN” page shown in FIG. 12A. The controller 110 sends this “LOGIN” page to the user terminal 300 having sent the login request, via the communications section 160.

The user terminal 300 receives the “LOGIN” page sent from the server 500, and displays the received “LOGIN” page on the display section. After login information including a user ID (a customer ID), a password of the user, etc. is input in this “LOGIN” page, the user terminal 300 sends the input login information to the server 500.

Upon reception of the login information from the user terminal 300, the controller 110 searches the customer-information database 120 for a combination of the corresponding customer ID and password in association with each other.

In the case where the controller 110 can not find a corresponding combination of the above from the customer-information database 120 (Step S101: NO), it concludes that the requested customer is not a registered customer, and terminates the transmission process.

In the case where the corresponding combination of the customer ID and password is successfully searched out (Step S101: YES), the controller 110 authorizes the user terminal 300 to login the Web server 140. At this time, the Web server 140 sends a cookie file including customer ID Information to the corresponding user terminal 300. Based on this cookie file, the Web server 140 identifies any user terminal 300 which may try to access the Web server 140 afterwards.

After the controller 110 authorizes the user terminal 300 to login the Web server 140, it controls the Web server 140 to create a menu page shown in FIG. 12B, and sends the created menu page to the user terminal 300 via the communications section 160 (Step S102).

The user terminal 300 receives the menu page sent from the server 500 and displays the received menu page on the display section. As shown in FIG. 12B, the menu page includes information items of “Update Registered Information” and “Purchase”, for example. (Note that some items of “Update Registered Information” and “Purchase” are included in the hypertext format.) The item “Update Registered Information” is linked to a Web page for updating the registered information, while the item “Purchase” is linked to a Web page for displaying product information.

The customer operates the user terminal 300 to select a predetermined information item included in the menu page shown in FIG. 12B, thereby requesting the server 500 to send a target Web page. In response to this request, the controller 110 of the server 500 carries out an information providing process S200 included in the transmission process of FIG. 11.

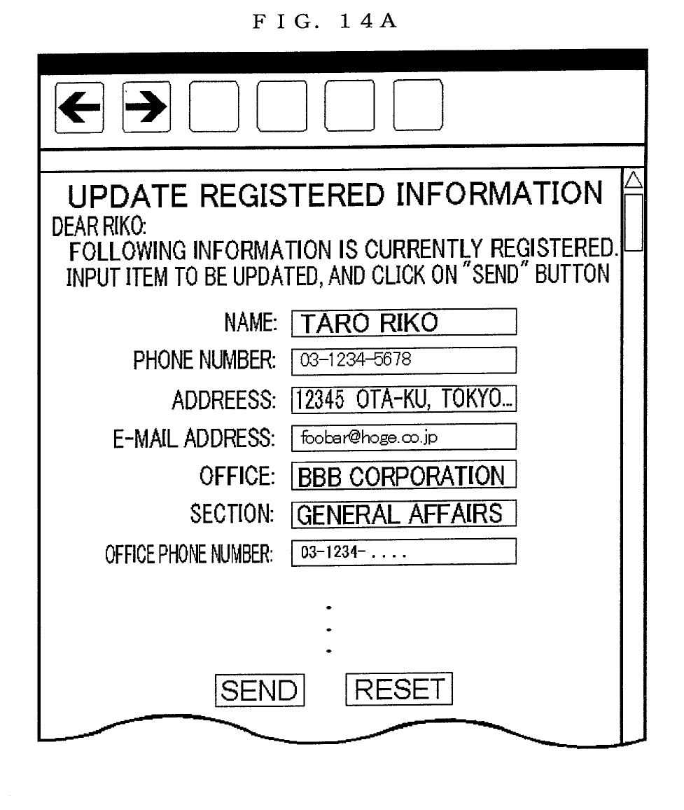

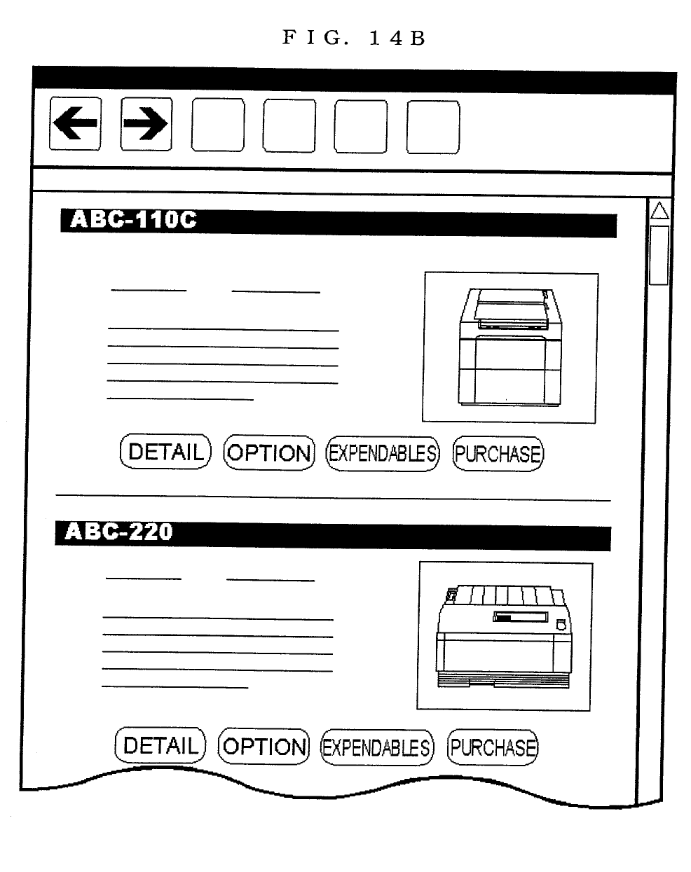

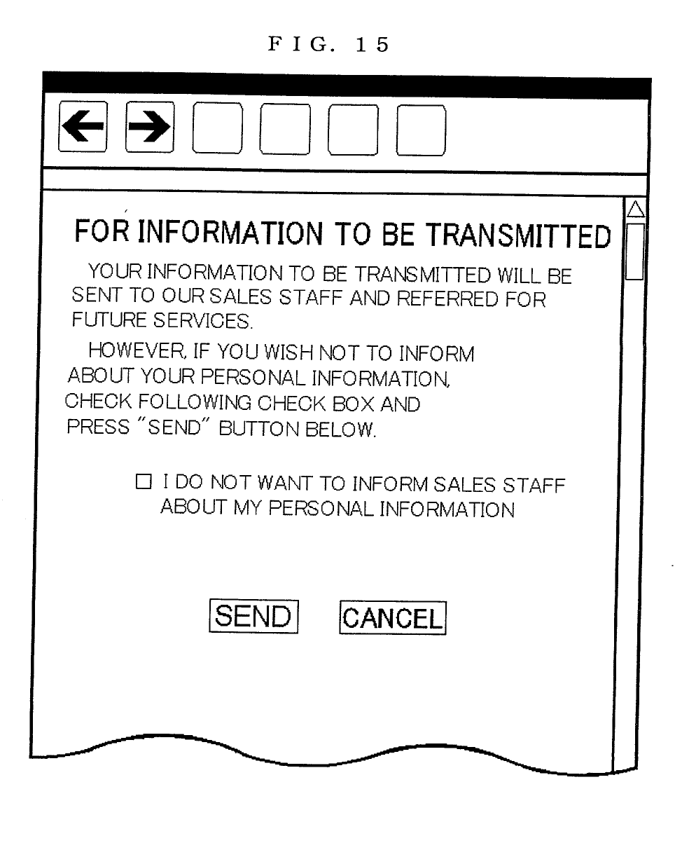

The information providing process of the step S200 will now be described with reference to the flowchart shown in FIG. 13. The controller 110 determines whether the item of “Update Registered Information” is selected by the user terminal 300 (Step S201). In the case where it is determined that the item “Update Registered Information” is selected, the controller 110 creates a predetermined “registration update form” and sends the created form to the user terminal 300 (Step S202). Specifically, the controller 110 controls the Web server 140 to create a “registration update form” in a preset format, and reads out corresponding customer information from the customer-information database 120. Then, the controller 110 inserts a customer name, customer phone number, customer address, e-mail address, office, section name and office phone number, into the “registration update form”, to create the “registration update form” shown in FIG. 14A.

The controller 110 sends thus created “registration update form” to the user terminal 300.

The user terminal 300 then receives and displays the “registration update form” sent from the server 500. As illustrated in FIG. 14A, in this “registration update form”, customer information including the customer name, phone number and e-mail address are inserted in advance. Thus, the customer needs to simply update the displayed customer information.

Additionally, the “registration update form” includes buttons of “send” and “reset”. For example, the button “send” is a button for sending request information for requesting to update the customer information to the server 500, in accordance with the information input in the “registration update form”, and is selected by the customer.

After the controller 110 sends this “registration update form” to the user terminal 300, it completes the information providing process, and returns to the procedures of the product/sales information transmission process shown in FIG. 11.

In the step S201, in the case where it is determined that the item of “update registered information” is not selected, the controller 110 determines whether the item of “product information” is selected by the user terminal 300 (Step S203).

In the step S203, in the case where the item of “product information” is not selected by the user terminal 300, the controller 110 terminates the information providing process, and returns to the procedures of the product/sales information transmission process of FIG. 11.

On the contrary, in the case where it is determined that the item of “product information” is selected, the controller 110 creates a product information page and sends the created product information page to the user terminal 300 (Step S204). Specifically, the controller 110 controls the Web server 140 to create the product information page shown in FIG. 14B, and sends the created product information page to the user terminal 300 via the communications section 160.

The user terminal 300 receives the product information page sent from the server 500 and displays the received page on the display section. As shown in FIG. 14B, this product information page includes descriptions and images of product items in association with each other.

In the product information page, several buttons of “Detail”, “Option”, “Expendable Supplies” and “Purchase” are sent in association with each product item. Such buttons are selected in order to request the server 500 to send another Web page corresponding to the button. For example, if the customer selects the button “Detail” (by clicking on the button “Detail” using a mouse, etc.), request information for requesting a Web page including detail information of the product item is sent to the server 500.

After the controller 110 sends the product information page to the user terminal 300, it completes the information providing process, and returns to the procedures of the product/sales information transmission process of FIG. 11.

As shown in FIG. 11, the controller 110 determines whether corresponding request information has been received (Step S103). In this case, in particular, the controller 110 determines that the corresponding request information has been received, in the case where request information is sent from the user terminal 300 displaying the “registration update form” shown in FIG. 14A or in the case where request information is sent from the user terminal 300 displaying the product information page shown in FIG. 14B.

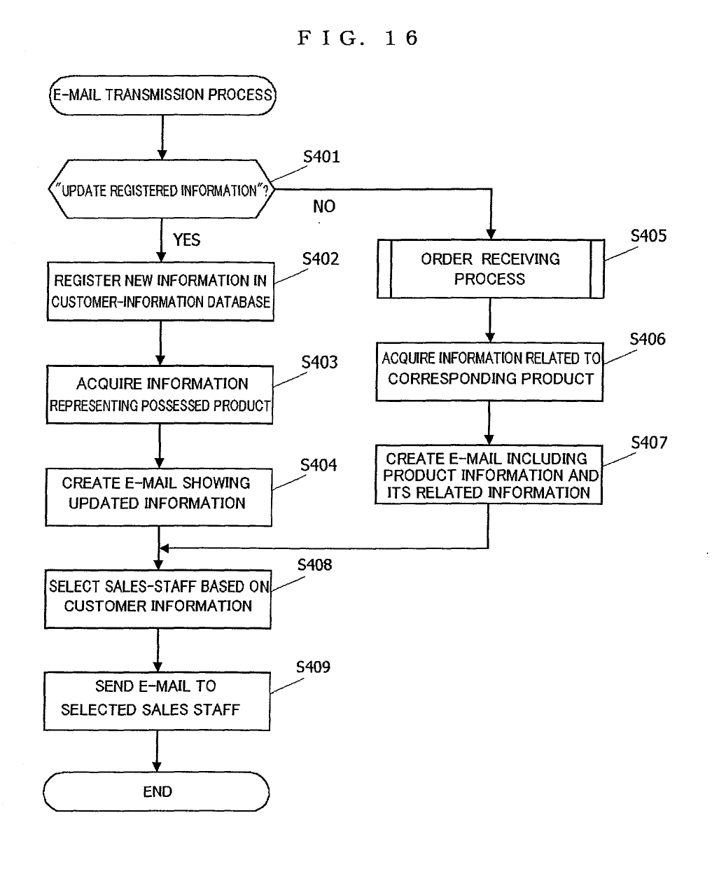

In the case where it is determined that the request information is received from the user terminal 300, the controller 110 creates a notice-confirmation page and sends the created notice-confirmation page to the user terminal 300 (Step S104). Specifically, the controller 110 controls the Web server 140 to create the notice-confirmation page shown in FIG. 15 and sends the created notice-confirmation page to the user terminal 300 via the communications section 160.

The user terminal 300 receives the notice-confirmation page sent from the server 500, and displays the received notice-confirmation page on the display section. As shown in FIG. 15, this notice-confirmation page has a check box for confirming whether to send the customer information to the sales staff. Depending on whether the check box is marked, it is determined whether the request information sent form the user terminal 300 should be sent to the sales staff. That is, in the case where the check box is not marked, the contents of the request information is sent to the sales staff also, and will be used for future services. In the case where the check box is marked, the contents of the request information is not sent to the sales staff.

The notice-confirmation page has some buttons of “send” and “cancel”, as shown in FIG. 15. For example, the button of “send” is a button for requesting the transmission of the information input in the notice-confirmation form, and is selected by the customer.

If the “send” button is selected by the user terminal 300, the controller 110 determines whether the customer consents to informing the sales staff about the user information (Step S105). That is, the controller 110 determines whether the “send” button has been selected in a state where the check box is not marked by the user terminal 300 in the notice-confirmation page shown in FIG. 15.

In the case where it is determined that the customer does not consent to informing the sales staff about the user information, and in the case where the corresponding request information is not received in the above-described step S103, the controller 110 executes a process corresponding to the received request information (Step S300). Particularly, the controller 110 executes a process corresponding to the request information (e.g. a process for sending the product information page to the user terminal 300), without informing the sales staff of the contents of the request information.

On the contrary, in the case where it is determined that the customer consents to informing the sales staff about the user information, the controller 110 carries out an e-mail transmission process of step S400.

The e-mail transmission process S400 included in the product-sales information transmission process will now be explained with reference to the flowchart of FIG. 16.

The controller 110 determines whether the request information is the “Update Registered Information” (Step S401). In this case, the controller 110 determines whether the request information has been sent from the user terminal 300 displaying the above-described “registration update form” shown in FIG. 14A.

In the case where it is determined that the request information is the “Update Registered Information”, the controller 110 accesses the customer-information database 120, and updates the customer information based on the request information (Step S402).

The controller 110 acquires product information (possessed-product information) representing products currently possessed by the customer (Step S403).

The controller 110 provides the e-mail server 150 with information representing a change to be made in the registered information, and sends an instruction to the e-mail server 150 to create an e-mail showing the change (Step S404).

In the above-described step S401, in the case where it is determined that the request information is not the “Update Registered Information” (i.e. the “purchase” button is selected), the controller 110 executes a predetermined order receiving process (Step S405). For example, the controller 110 controls the e-mail server 150 to send an e-mail for confirming whether to purchase the product item to the customer, and sends ordering data to the delivery section of the company.

The controller 110 accesses the product-information database 130 and acquires related information of the product item, from its corresponding product information (Step S406). That is, the controller 110 acquires attachment information, expendable-supply information and option information, from the corresponding product information.

The controller 110 provides the e-mail server 150 with the product information and its related information, and sends an instruction to the e-mail server 150 to create an e-mail including these information (Step S407).

The controller 110 selects a sales staff based on the customer information (Step S408). Specifically, the controller 110 searches the customer information database 120. In the case where the staff ID is set in the customer-information database 120, the controller 110 selects the sales staff corresponding to the staff ID.

On the contrary, in the case where the staff ID is not set in the customer-information database 120, the controller 110 obtains an area code based on the address, etc. included in the customer information, and acquires information (model number of a target product item) for specifying the product included in the contact information. Based on the obtained area code and product model number, the controller 110 searches for the sales-staff database 130, and selects a sales staff being in charge of the product item in the area.

The controller 110 sends an e-mail to the selected sales staff (Step S409). Specifically, the controller 110 searches the sales-staff database 130 for an e-mail address corresponding to the staff ID of the selected sales staff. After this, the controller 110 sets the obtained e-mail address of the sales staff as the addressee of the e-mail which is created in the step S404 or Step S407. The controller 110 controls the e-mail server 150, and sends the created e-mail to the sales staff.

The sales-staff terminal 400 detects whether an e-mail has been received at a predetermined timing, retrieves the e-mail into the terminal in accordance with the operations of the sales staff, and displays the contents of the retrieved e-mail. The sales staff specifies a corresponding customer based on the e-mail displayed on the sales-staff terminal, and makes contact with the specified customer so as to perform sales activities. For example, the sales staff may sell those attachments, expendable supplies, or any other items related to the product item which the customer has just newly purchased, thereby performing the sales activities.

Accordingly, having executed product-sales information transmission process, the e-commerce and actual sales activities can be done in cooperation with each other.

In the above-described first and second embodiments, the explanations have been made to the case where the sales staff operates the sales-staff terminal 400. However, the present invention is not limited to this case, and can be employed in the case where sales-staff terminal 400 is operated by the service staff or maintenance staff, etc.

The system of the present invention can be realized by a general computer, without the need for a dedicated system. A program and data for controlling a computer to execute the above-described processes may be recorded on a medium (a floppy disk, CD-ROM, DVD or the like) and distributed, and the program may be installed into the computer and run on an OS (Operating System) to execute the above-described processes, thereby achieving the system of the present invention. The above program and data may be stored in a disk device or the like in the server device on the Internet, and embedded in a carrier wave. The program and data embedded in the carrier wave may be downloaded into the computer so as to realize the system of the present invention.

Various embodiments and changes may be made thereonto without departing from the broad spirit and scope of the invention. The above-described embodiments are intended to illustrate the present invention, not to limit the scope of the present invention. The scope of the present invention is shown by the attached claims rather than the embodiments. Various modifications made within the meaning of an equivalent of the claims of the invention and within the claims are to be regarded to be in the scope of the present invention.

This application is based on Japanese Patent Application Nos. 2001-020565 and 2001-020546 both filed on Jan. 29, 2001, and including specification, claims, drawings and summary. The disclosure of the above Japanese Patent Application is incorporated herein by reference in its entirety.

What is claimed is:

1. A server device comprising:
a communications section which sends and receives predetermined information to and from at least one customer terminal and at least one sales-staff terminal which are connected with each other through a communications network;
a product-information sender which sends predetermined product information to the at least one customer terminal through said communications section;
a contact-information receiver which receives contact information sent from the at least one customer terminal in association with the product information sent by said product-information sender, through said communications section;
an information acquirer which acquires information regarding a customer corresponding to the at least one customer terminal, in accordance with the contact information received by said contact-information receiver; and
a sales-information sender which sends the information acquired by said information acquirer and the contact information received by said contact-information receiver, to the at least one sales-staff terminal through said communications section.

2. The server device according to claim 1, wherein:
said product-information sender sends a Web page including predetermined product information to the at least one customer terminal; and
said sales-information sender sends an e-mail including the information acquired by said information acquirer and the contact information received by the contact-information receiver, to the at least one sales-staff terminal.

3. The server device according to claim 1, further including:
a customer-information storage section which stores information regarding at least one registered customer, in advance; and
a staff-information storage section which stores information regarding at least one sales staff in association with the information stored in said customer-information storage section, and
wherein said information acquirer acquires information regarding the customer corresponding to the at least one customer terminal from said customer-information storage section, and acquires also the information regarding a sales staff corresponding to the customer from said staff-information storage section, and
said sales-information sender sends an e-mail including the information regarding the customer and acquired by said information acquirer and the contact information received by said contact-information receiver, to an e-mail address included in the information regarding the at least one sales staff and acquired by said information acquirer.

4. A method for supporting sales performance, comprising the steps of:
sending predetermined product information to at least one customer terminal via a communications network;
receiving contact information sent from the at least one customer terminal in association with the product information sent at said step of sending the product information;
acquiring information regarding a customer corresponding to the at least one customer terminal, in accordance with the contact information received at said step of receiving the contact information; and
sending the information acquired at said step of acquiring the information and the contact information received at said step of receiving the contact information, to at least one sales staff terminal through a communications network.

5. The method according to claim 4, wherein:
said step of sending the product information includes a step of sending a Web page including the predetermined product information to the at least one customer terminal; and
said step of sending the sales information includes a step of sending an e-mail including the information acquired at said step of acquiring the information, said at least one sales staff terminal.

6. A method for supporting sales performance, comprising the steps of:
sending a Web page including product information, in response to accessing from at least one customer terminal through a communications network, to the at least one customer terminal;
receiving contact information sent from said at least one customer terminal in association with the product information sent at said step of sending the product information;
acquiring information regarding a customer corresponding to said at least one customer terminal, from a predetermined storage section storing customer information, in accordance with the contact information received at said step of receiving the contact information;
acquiring information regarding at least one corresponding sales staff, from a predetermined storage section storing sales staff information, in accordance with the information acquired at said step of acquiring the information regarding the customer; and
setting, as an addressee, an e-mail address included in the information acquired at said step of acquiring the information regarding the at least one corresponding sales staff, thereby sending an e-mail including the information acquired at said step of acquiring the customer information and the contact information received at said step of receiving the contact information, said to at least one sales-staff terminal of the at least one corresponding sales staff through a communications network.

7. A computer readable recording medium recording a program for controlling a computer to execute a method for supporting sales performance comprising the steps of:
sending predetermined product information to at least one customer terminal via a communications network;
receiving contact information sent from the at least one customer terminal in association with the product information sent at said step of sending the product information;
acquiring information regarding a customer corresponding to the at least one customer terminal, in accordance with the contact information received at said step of receiving the contact information; and
sending the information acquired at said step of acquiring the information and the contact information received at said step of receiving the contact information, to at least one sales staff terminal through a communications network.

8. A data signal embodied in a carrier wave and representing an instruction sequence for controlling a computer to execute a method for supporting sales performance comprising the steps of:
sending predetermined product information to at least one customer terminal via a communications network;
receiving contact information sent from the at least one customer terminal in association with the product information sent at said step of sending the product information;
acquiring information regarding a customer corresponding to the at least one customer terminal, in accordance with the contact information received at said step of receiving the contact information; and
sending the information acquired at said step of acquiring the information and the contact information received at said step of receiving the contact information, to at least one sales staff terminal through a communications network.

9. A server device comprising:
a communications section which sends and receives predetermined information to and from at least one customer terminal and at least one sales-staff terminal connected with each other through a communications network;
a product-information sender which sends predetermined product information to the at least one customer terminal through said communications section;
a request-information receiver which receives request information, sent form the at least one customer terminal in association with the product information sent by said product-information sender, through said communications section;
an information acquirer which acquires information regarding a customer corresponding to the at least one customer terminal and product information corresponding to the request information, in accordance with the request information received by said request-information receiver; and
a sales-information sender which sends the information acquired by said information acquirer to the at least one sales-staff terminal through the communications section.

10. The server device according to claim 9, wherein:
said product-information sender sends a Web page including the predetermined product information to the at least one customer terminal; and
said sales-information sender sends an e-mail including the information acquired by said information acquirer to the at least one sales-staff terminal.

11. A server device comprising:
a customer-information storage section which stores in advance information regarding at least one registered customer;
a staff-information storage section which stores information regarding at least one sales staff in association with information regarding the at least one customer stored in said customer-information storage section;
a communications section which sends and receives predetermined information to and from at least one customer terminal and at least one sales-staff terminal through a communications network;
a customer-information sender which sends the information stored in said customer-information storage section to the at least one customer terminal through said communications section;
a request-information receiver which receives request information, sent from the at least one customer terminal in association with the information sent by said customer-information sender and for requesting to update registered information, through said communications section;
an information updating section which updates the information regarding the at least one customer and being received by said request-information receiver; and
a sales-information sender which sends the information updated by said information updating section, to the at least one sales-staff terminal through the communications section.

12. The server device according to claim 11, wherein:
said customer-information sender sends a Web page including the customer information corresponding to the at least one customer terminal to the at least one customer terminal; and
said sales-information sending section sends an e-mail including the information updated by said information updating section, to said at least one sales-staff terminal.

13. A method for supporting sales performance, comprising the steps of:
sending predetermined product information, in response to accessing from at least one customer terminal through a communications network, to the at least one customer terminal;
receiving request information sent from the at least one customer terminal in association with the product information sent at said step of sending the product information;
acquiring information regarding a customer corresponding to the at least one customer terminal and the product information corresponding to the request information, in accordance with the request information received at said step of receiving the request information; and
sending the information acquired at said step of acquiring the information to said at least one sales-staff terminal through a communications network.

14. The method according to claim 13, wherein:
said step of sending the product information includes a step of sending a Web page including the predetermined product information to the at least one customer terminal; and
said step of sending the sales information includes a step of sending an e-mail including the information acquired at said step of acquiring the information, to the at least one sales-staff terminal.

15. A method for supporting sales performance, comprising the steps of:
sending information regarding at least one customer registered in a predetermined storage section, in response to accessing from the at least one customer terminal through a communications network, to the at least one customer terminal;
receiving request information, sent from the at least one customer terminal in association with the customer information sent at said step of sending the customer information and representing a request for updating registered information;
updating the information registered in the predetermined storage section, in accordance with the request information received at said step of receiving the request information; and
sending the information updated at said step of updating the information, to at least one sales-staff terminal through a communications network.

16. The method according to claim 15, wherein:
said step of sending the customer information includes a step of sending a Web page including the customer information corresponding to the at least one customer terminal, to the at least one customer terminal; and
said step of sending the sales information includes a step of sending an e-mail including the information updated at said step of updating the information, to the at least one sales-staff terminal.

17. A computer readable recording medium recording a program for controlling a computer to execute a method for supporting sales performance, said method comprising the steps of:
sending predetermined product information, in response to accessing from at least one customer terminal through a communications network, to the at least one customer terminal;
receiving request information sent from the at least one customer terminal in association with the product information sent at said step of sending the product information;
acquiring information regarding a customer corresponding to the at least one customer terminal and the predetermined product information corresponding to the request information, in accordance with the request information received at said step of receiving the request information; and
sending the information acquired at said step of acquiring the information to at least one sales-staff terminal through a communications network.

18. A computer readable recording medium recording a program for controlling a computer to execute a method for supporting sales performance, said method comprising the steps of:
sending information regarding a customer and being stored in a predetermined storage section, in response to accessing from at least one customer terminal through a communications network, to the at least one customer terminal;
receiving request information for requesting to update registered information, sent from the at least one customer terminal in association with the customer information sent at said step of sending the information;
updating the customer information stored in the predetermined storage section, in accordance with the request information received at said step of receiving the request information; and
sending the customer information updated at said step of updating the customer information, to at least one sales-staff terminal through a communications network.

19. A data signal embodied in a carrier wave and representing an instruction sequence for controlling a computer to execute a method for supporting sales performance, said method comprising the steps of:
sending predetermined product information, in response to accessing from at least one customer terminal through a communications network, to the at least one customer terminal;
receiving request information sent from the at least one customer terminal in association with the product information sent at said step of sending the product information;
acquiring information regarding a customer of the at least one customer terminal and the product information corresponding to the request information, in accordance with the request information received at said step of receiving the request information; and
sending the information acquired at said step of acquiring the information to at least one sales-staff terminal through a communications network.

20. A data signal embodied in a carrier wave and representing an instruction sequence for controlling a computer to execute a method for supporting sales performance, said method comprising the steps of:
sending information regarding a customer registered in a predetermined storage section, in response to accessing from at least one customer terminal through a communications network, to the at least one customer terminal;
receiving request information sent from the at least one customer terminal in association with the customer information sent at said step of sending the customer information;
updating the information regarding the customer stored in the predetermined storage section, in accordance with the request information received at said step of receiving the request information; and
sending the information including the information updated at said step of updating the information to at least one sales-staff terminal through a communications network.
